(19) United States
(12) Patent Application Publication
(10) Pub. No.: US 2007/0066304 A1
(43) Pub. Date: Mar. 22, 2007

(54) Method and apparatus for connecting to stable access point using connection history

(75) Inventor: Youne-sang Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/515,901

(22) Filed: Sep. 6, 2006

(30) Foreign Application Priority Data
Sep. 7, 2005 (KR) 2005-83320

(51) Int. Cl. H04Q 7/20

(52) U.S. Cl. 455/436

(57) ABSTRACT

A method and apparatus to provide guidance to be associated with a stable access point using a previous connection history, the method includes receiving data from a plurality of access points which are available in a wireless network and searching connection information related to a connection history corresponding to the respective access point using an identifier of respective access point included in the received data; selecting a first access point which can be used to preferentially connect to the wireless network among the plurality of access points according to a predetermined standard and outputting a guide information of the first access point; connecting to the wireless network through the first access point; and storing connection information including results of a transmission and/or receipt of the data.

### CROSS-REFERENCE TO RELATED APPLICATION

This application claims the benefit of Korean Application No. 2005-83320, filed on Sep. 7, 2005 in the Korean Intellectual Property Office, the disclosure of which is incorporated herein by reference.

### BACKGROUND OF THE INVENTION

1. Field of the Invention

Aspects of the present invention relate to a system that accesses a wireless network. More particularly, aspects of the present invention relate to a method and apparatus to provide a guide or guidance to access a stable access point for a wireless network using a connection history.

2. Description of the Related Art

Due to the widespread use of the Internet and a sharp increase in multimedia data, there is an increasing demand for very high speed communication networks. Among such networks is a local area network (LAN), which has a transmission rate of 1-4 Mbps, and was introduced in the latter half of the 1980s, High speed Ethernet currently used has speeds of 100 Mbps. Further, active research on Gigabit Ethernet is being conducted. Also, attempts to conduct wireless network communications have promoted research and development of a wireless local area network (WLAN). As a result, WLANs have been spreading. WLANs have lower data transmission rates and are less stable than wired LANs, but can be configured without wires, thereby allowing device mobility. Accordingly, the WLAN market is growing.

To meet the demand for faster data transmission rates and the development of wireless transmission technologies, the IEEE 802.11a standard was improved. In addition, the IEEE 802.11b, IEEE 802.11g, IEEE 802.11n, and IEEE 820.11s standards have been standardized and standards for others are being discussed in standardization conferences.

In the WLAN environment, LAN services are provided to wireless terminals using access points (APs). APs are devices that are similar to a hub of the wired LAN environment. Computers, notebook computers, and others are connected to the Internet or a network through the APs.

FIG. 1 illustrates a notebook computer accessing a network through access points. A notebook computer 21, which functions as a client system, receives broadcasting signals periodically broadcasted by access points 11, 12, 13 and 14. The notebook computer 21 processes the received broadcasting signals and information included in the received broadcasting signals. The information included in the broadcasting signals are information on a network to be connected through the access points, information necessary for performing communications with the access points, and other information. The various information are output to the notebook computer 21 and displayed, as denoted by numeral 31, thereby allowing a user to obtain the various information on the access points.

The user selects one of the an access points 11, 12, 13, 14 from a list of searched access points displayed on the notebook computer 21, and connects the notebook computer 21 to the selected access point 11, 12, 13, or 14. When they are connected, wireless communications between the selected access point 11, 12, 13, or 14 and the notebook computer 21 are possible. When the connection is unsuccessful, the user may select another access point 11, 12, 13, or 14 from the list, and try to connect the notebook computer 21 to the other access point 11, 12, 13, or 14.

In FIG. 1, the available access point transmits a beacon signal when it begins operating. The notebook computer 21 provided with a wireless LAN module receives the beacon signal. The notebook computer 21, which receives the beacon signal, may arrange a list of access points as denoted by the numeral 31, or display information on current operational modes of the access points, as denoted by the numeral 32. The user selects an access point to be connected to the notebook computer 21, from the list of the access points displayed on a screen, and tries to connect to the notebook computer 21 to the selected access point.

A utility program that aids in establishing a wireless connection may support a function allowing the user to pre-store settings of access points used frequently among the searched access points, in the form of a profile. When the profile is executed, the notebook computer 21 preferentially connects to the access point with the pre-stored setting. Otherwise, the profile is executed by another method designated by the user. However, neither method provides information that can be referenced when the user wants to select an access point offering a good connection.

Conventionally, a method for providing information on the accessibility, communication speeds, monetary charges, and others of currently available access points in a list is disclosed in Japanese Unexamined Patent Publication No. 2000-83284 and European Patent publication No. 0 967 815. However, the reference merely indicates the quality of current communications connections.

The conventional method disclosed in FIG. 1 does not provide information necessary to enable a user to select a connection from a list based on information on available access points. The number of connection failures is higher because information on previous connection failures is not utilized. Further, problematic access points that cause frequent troubles are not distinguished from non-problematic access points.

### SUMMARY OF THE INVENTION

Additional aspects and/or advantages of the invention will be set forth in part in the description which follows and, in part, will be obvious from the description, or may be learned by practice of the invention.

Aspects of the present invention provide information for selecting an access point when a user attempts to connect to a wireless network.

Aspects of the present invention provide information which is the stored result of previous connections to a wireless network to enable connections to an access point with a high performance.

According to an aspect of the present invention, there is provided a method for guiding to be connected to a stable access point using a previous connection history, the method including receiving data from a plurality of access points which exists in a wireless network and searching connection histories and related connection information on the respective access point using an identifier of the respective access point included in the received data; selecting a first access point which can preferentially connect according to a predetermined standard among the plurality of access points in response to the searched information and outputting guide information on the first selected access point; connecting to the wireless network through the first access point; and transmitting/receiving data to/from the wireless network through the first connected access point and storing connection information including results of transmitting/receiving data.

According to another aspect of the present invention, there is provided a wireless communicable system, including a wireless transmitting/receiving unit connecting to a wireless network through an access point and transmitting/receiving data to/from the access point; a storage unit storing connection information on the access point; an information updating unit newly storing connection information on the connected access point in the storage unit or changing the connection information stored in the storage unit; and a comparison selecting unit searching connection information related to connection histories corresponding to respective access point using an identifier of the access points included in control data and related connection information and preferentially connecting to a first access point selected according to a predetermined standard, when two or more access points transmit the control data.

According to still another aspect of the present invention, there is provided a network system, including an access point which configures a wireless network and a system for associating to the wireless network through the access point, in which the system searches connection information relating to previous connection histories of the access points and outputs guide information so as to preferentially connect to a first access point selected according to a predetermined standard among the access points, and associates to the first access point, when the plurality of access points exist in the wireless network to be connected.

According to still another aspect of the present invention, a method of providing guidance for access points of a network, includes comparing metrics for a plurality of access points, determining at least one of the plurality of access points to recommend to connect to the network based on the metrics, and outputting the recommendation.

According to still another aspect of the present invention, a network communication system to provide guidance for access points of a network, includes a recommending unit to compare metrics for a plurality of access points, determine at least one of the plurality of access points to recommend to connect to the network based on the metrics, and output the recommendation.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 illustrates a notebook computer that is connected to a network through access points;

FIG. 2 illustrates a notebook computer that is connected to a network through one or more access points according to an aspect of the present invention;

FIG. 3 is a block diagram illustrating a client system according to an aspect of the present invention;

FIG. 4 is a flow chart illustrating a process, executed by the client system of FIG. 3, of storing and utilizing of data for access points during wireless data communications according to an aspect of the present invention;

FIG. 5 is a flow chart illustrating a process of updating data in an information updating unit when the client system of FIG. 3 accesses an access point according to an aspect of the present invention; and

FIG. 6 is an excerpt of a database illustrating access point connection history, which is stored in a storage unit, according to an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

Hereinafter, according to aspects of the present invention, a method and apparatus for a system to guide access to a stable access point using a previous connection history, will be explained in detail with reference to the accompanying drawings of block diagrams or processing flow charts. At this time, it will be understood that an association of respective block of block diagrams and respective steps of flow charts may be performed by computer program instructions. Since the computer program instructions may be mounted on a processor of a general purpose computer, a special purpose computer or processors of other programmable data processing equipments respectively, the instructions which are performed by the processor of other programmable data processing equipments or the computer generated means for performing functions explained in block(s) of flow charts. Since the computer program instructions make it possible for them to be stored in a computer available memory or a computer readable memory which can direct the computer or other programmable data processing equipments so as to implement functions in a specific mode, the instructions stored in the computer available or the computer readable memory may produce manufacturing items including an instructing means for performing functions explained in the blocks and the flow charts. Since the computer program instructions may be mounted on the computer or other programmable data processing equipments, the instructions for performing a series of operation steps on the computer or other programmable data processing equipments so as to generate a process executed by the computer and performing the computer or other programmable data processing equipments, may also provide steps for executing functions explained in blocks of the flow charts.

Further, respective blocks may represent a part of a module, a segment or a code including one or more executable instructions for executing specific logic function(s). Additionally, it should be noticed that functions referred to in blocks or steps may be generated without regard to orders in some alternate aspects. In other words, it is possible that two blocks or steps illustrated in succession are substantially and simultaneously performed or sometimes reversely performed according to the corresponding functions.

As described above, an access failure rate in accessing a wireless network may be decreased by displaying one or more lists of access points to allow a user to select an access point. In other words, if the lists are provided without any guidance on the plurality of access points, a user may select an access point having a low quality connection, such as a low performance or connection rate. Accordingly, a user is provided with guidance so that the user can select an access point having high quality, such as a high connection rate. Further, the guidance may be provided based on information of previously used access points.

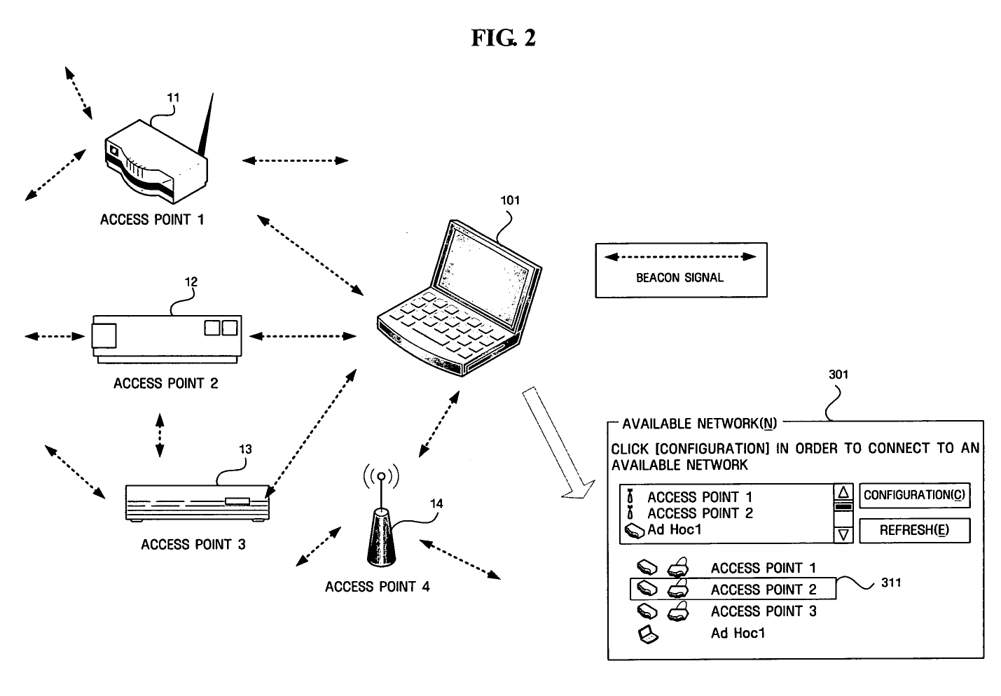

FIG. 2 is a configuration diagram illustrating a wireless network system according to an aspect of the present invention. A term of a “unit”, in other words, a “module” or a “table” which is used in the aspect, means a hardware element such as a Field Programmable Gate Array (FPGA) or an Application Specific Integrated Circuit (ASIC), and the module performs some functions. However, the module is not limited to mean only software or hardware. The module may be configured to be embedded in an addressable storage media or generate one or more processors. Accordingly, the module includes elements such as software elements, object-oriented software elements, class elements and task elements, processes, functions, attributions, procedures, subroutines, segments of program codes, drivers, firmware, microcode, circuits, data, databases, data structures, tables, arrays and/or variables. Functions provided in the elements and the modules may be associated with a smaller number of elements and modules or be separated into additional elements and modules. Moreover, the elements and modules may be implemented so as to regenerate one or more CPUs in a device.

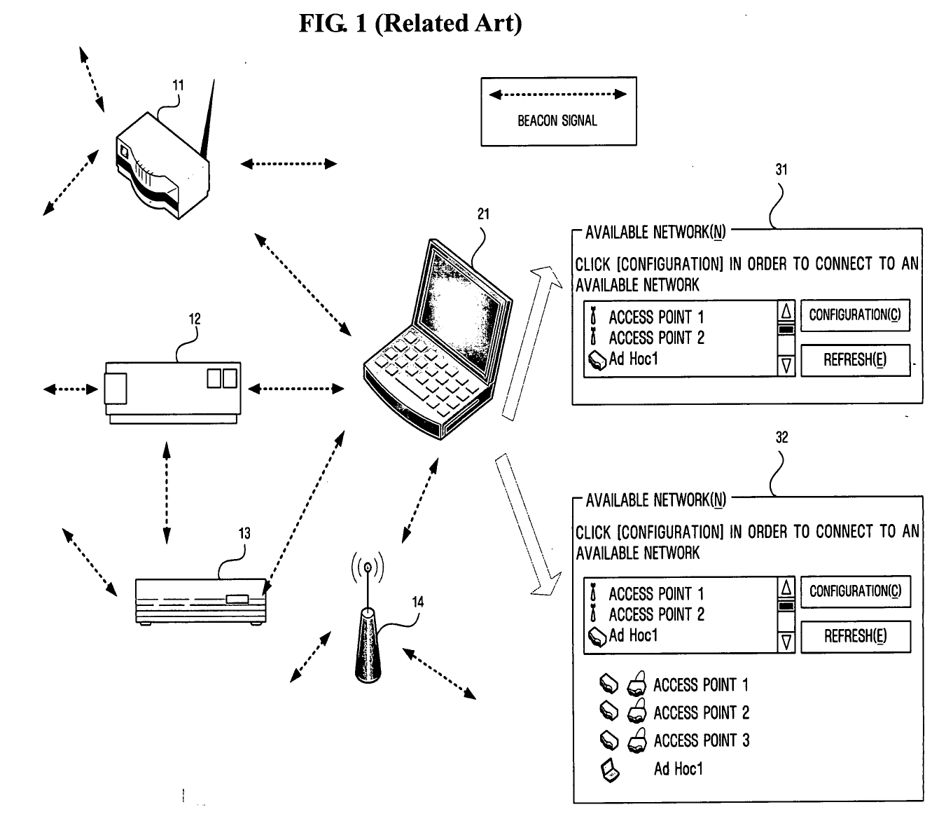

FIG. 2 is a configuration diagram illustrating a case that a device, such as a client system embodied by a notebook computer 101, is connected to a network through an access point. The client system such as the notebook computer 101 periodically receives a broadcasting signal from the one or more access points 11, 12, 13 and/or 14. The notebook computer 101 processes the received broadcasting signal and information included in the received broadcasting signal. For example, the information includes information on a network which can be connected through the access points and information necessary for communicating with the access points. The information is outputted by the notebook computer 101 as a screen 301 and a user may obtain information on the access points. By way of example, a plurality of the access points are outputted in the screen 301, and an aspect of the present invention gives guidance or recommends the access point 2 (12), from among the one or more access points 11, 12, 13, 14. Contrary to simply arranging searched access points without any guidance as shown in FIG. 1, the screen 301 outputs a selection indication of the access point 2, such as a highlight, having high connection performance based on a previous connection history from among the searched access points. Accordingly, the screen 301 provides a guide or guidance to enable the user to select the most desirable of the access points. In various aspects of the present invention, the output selection indication includes highlighting, chimes, checkboxes, and the like, which may be graphically represented on the screen 301.

In the configuration of FIG. 2, one or more of the access points 11, 12, 13, 14 transmit a broadcasting signal, such as a beacon signal, and the notebook computer 101 mounted with a wireless LAN module receives the beacon signal. The notebook computer 101 which receives the beacon signal may arrange a list or lists of the access point as shown in the screen 301, and/or represent information on a current operation mode of the available access point as shown in a screen 32 of FIG. 1.

The user selects the recommended access point 2 (12) through an indication, guidance, or highlight 311 among a list of available access points displayed on the screen 301 and tries to establish a connection between the access point 2 (12) and the computer 101.

When a plurality of the access points 11, 12, 13 and/or 14 are available and connectable, the notebook computer 101 tries to connect to the wireless network. After receiving the beacon signal transmitted from one or more of the access points 11, 12, 13, 14, the notebook computer 101 provides one or more lists of connectable access points according to the beacon signal in the screen 301. In the shown example, a connection with the access point 2 (i.e., device 12) from among the connectable access points may be recommended to the user based on information on previous connection history. For this purpose, it is desirable to maintain the previous connection history information relating to all or a limited number of past connections results which enable the user to select one of the access points. The connection history information is stored in a memory as a historical record of previous connections, and may be used to recommend or provide guidance to the user to use a specific access point and/or prevent the user from using the specific access point.

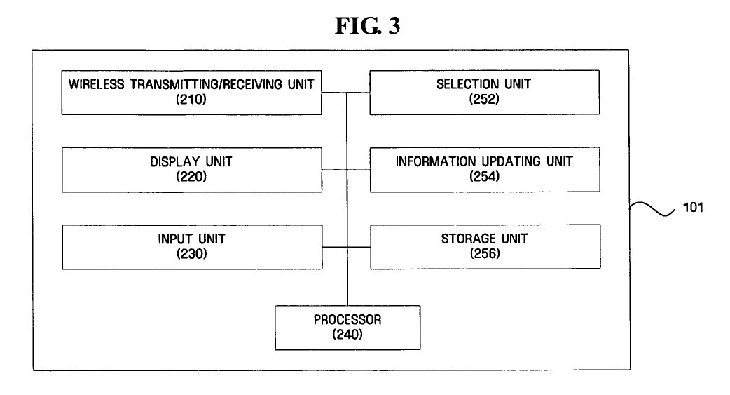

FIG. 3 is a configuration diagram illustrating a client system according to an aspect of the present invention. FIG. 3 mainly uses the notebook computer 101 as an example of a client system. However, the client system of FIG. 3 may include, not only the notebook computer 101, but also a handheld personal computer (HPC), a personal digital assistant (PDA), a desktop computer, and the like, each of which performs communication with the wireless network through the access point. In various aspects, the client system may also include personal communication and/or entertainment devices such as cell phones, digital music players, video game consoles, or any combination thereof. In other aspects, appliances such as refrigerators that have internet access capabilities and the like are included.

A notebook computer 101 is connected to the wireless network, and includes a wireless transmitting/receiving unit 210 (i.e., a wireless transmitting and/or receiving unit), a display unit 220, an input unit 230 and a processor 240 so as to provide other processing functions. Further, a comparison selecting unit 252, an information updating unit 254, and a storage unit 256 are included so as to provide recommendations or guidance regarding usage of the access point according to an aspect of the present invention. Further, the display unit 220 can be separately provided in other aspects of the present invention.

The notebook computer 101 displays on the display unit 220 the access point that would be recommended to establish a connection from the client system once signals from one or more of the access points are received. The notebook computer 101 includes the comparison selecting unit 252 to determine an access point to recommend by comparing a searched access point list with information on connection history stored in a storage unit 256. The notebook computer 101 also includes the information updating unit 254 to update information by comparing successful connection information to a wireless connection with the connection history stored in the storage unit 256 and to give priority to an access point recommended to establish the connection. The notebook computer 101 also includes the storage unit 256 to store newly updated information from the information updating unit 254 and to continuously transmit the updated information to the comparison selecting unit 252 and the information updating unit 254. In various aspects of the present invention, some or all of the above listed functions may be performed by a single unit, or a processor running a program.

The wireless transmitting/receiving unit 210 transmits and/or receives data according to a wireless protocol. The wireless protocol may be a wireless LAN protocol such as 802.11, a Bluetooth, a wireless USB or the like. The present invention is not limited to a specific type or a standard of the wireless protocol.

The display unit 220 displays an output of the result of the above data processing process to a user, which is a recommendation or guidance, and which may be highlighting of an access point. In general, the notebook computer 101 employs an LCD monitor, but may also employ various other display monitors. Such displays may be manufactured using an advanced display technology. Examples of such displays include plasma displays, organic light emitting diode (OLED) displays, and the like. As an example, the screen 301 for selecting an access point shown in FIG. 2 is outputted by the notebook computer 101 and displayed on the display 220.

The input unit 230 receives an input from an external source such as a keyboard, a mouse, a touch panel or the like. The user may use the keyboard, the mouse, a touch screen display or the like so as to select a specific access point in the screen 301 of FIG. 2.

The processor 240 processes data like a CPU and controls other equipments in the notebook computer 101. Further, the processor 240 controls transmission and/or reception of data through the wireless transmitting/receiving unit 210 and performs various processing when the user selects the specific access point through the input unit 230 from information outputted through the display unit 220.

The comparison selecting unit 252 determines an access point having a high quality connection or a higher priority from the list of access points based on one or more information. Such information includes, but is not limited to a number of previous connection of the access points, statistical information of the access point, and connection history. Once determined, the access points are arranged on the list according to the priority accorded based on the information. Each of the listed information is searched through the wireless transmitting/receiving unit 210 of a client system, and the comparison selecting unit 252 outputs the selected access point to the display unit 220 so as to enable the user to make selection. Accordingly, a function or a process of judging or determining which access point may secure a high connection rate or a safe connection based on the stored connection history is desirable.

The information updating unit 254 analyzes and updates connection history information stored in the storage unit 256 and connection success information which is inputted through one or more access points that transmits a beacon frame, and accords priority to the connection history. The priority information and newly received or updated information are again stored in the storage unit 256. Another operation of the information updating unit 254 provides and stores a priority of the updated connection history. Beacon frames are used to identify nearby wireless access points (AP) in passive scanning mode and can also be transmitted by the AP for polling purposes. The beacon frame sent by the AP contains control information and can be used by client systems to locate an AP.

At this time, data or information used to accord priority to the updated connection history may include the number of successful connections, the number of connection cut-off, and the like. The number of successful connections may be processed using a status code of an authentication response frame transmitted from the access point. Such a status code may be “0”, and the number of “0” may be counted to determine the number of successful connections. The number of the connection cut-offs may include the number of disassociation and de-authentication occurring while the wireless network is being used. The information updating unit 254 continuously stores and updates such information on the quality of data transmission and association when data are transmitted to and received from wireless LAN and the access point.

The storage unit 256 stores information on a successful connection which occurs when the access point is successfully connected to the client system and a wireless data communication link is established. The information updating unit 254 judges and stores storage mode information or other information to be stored. Further, if information on a specific access point has been stored, a process to update the information is performed through the information updating unit 254 and the updated information is stored in the storage unit 256. If the information on the relevant access point already exists in the stored connection history, necessary data values which are referred when determining a priority in the information updating unit 256 are stored. Such values include the number of successful connections and connection cuts or disconnections. If information on a relevant access point does not already exist in the stored connection history, new information as to the relevant access point may be added. Types of stored connection history information include a Service Set Identifier (SSID) of a corresponding access point, a Media Access Control (MAC) address, the number of connection success, status code information included in a response management frame, the number of cut-offs, such as disassociation and/or de-authentication, the strength of an average signal, connection quality or the like.

The disassociation may implement a disassociation frame that store more concrete and additional connection related information by obtaining a reason code as to the quality of the connection to the disassociation. For example, a reason code of “5” may be used, and may occur several times, which means that the access point can not process all of the connected clients. The comparison selecting unit 252 may be utilized as information necessary for determining a priority with reference to such information. In various aspects of the present invention, such disassociations or disconnections may occur intentionally to obtain statistics or reason codes for the access point, or to secure a better connection. In various aspects of the present invention, even while an access point is used, a recommendation to change an access point may be made if a better access point becomes available, or if another access point would offer a better connection.

The information updating unit 254 and the comparison selecting unit 252 can be combined into a recommending unit (not shown) which retrieves and compares stored metrics for a plurality of access points, determines at least one of the plurality of access points to recommend to connect to the network based on the compared metrics, and outputs the recommendation.

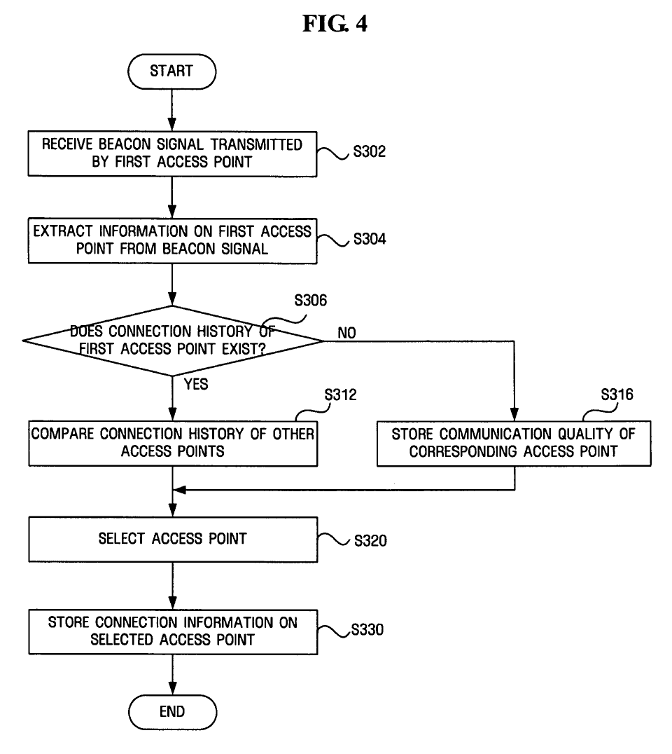

FIG. 4 is a flow chart illustrating a process in which a client system stores and utilizes results of transmitting/receiving data and the access point for the wireless data communication according to an aspect of the present invention.

To be connected to the wireless network, it is necessary to be associated and connected with the access point. Accordingly, a beacon frame transmitted from the access point, which configures the wireless network, is received in operation S302. In this process, when a plurality of access points is available in the wireless network, beacon frames of various access points may be received. Since information on the access points exist in the received beacon frame, the information on the access point is extracted in operation S304. Then a search is performed to determine whether there is connection history information due to a previous connection and a result based on the extracted information on the access point in operation S306. While described as being from a previous connection, it is understood that this history information can be from connections by others and which is shared with the computer 101.

Likewise, if various access points are available and beacon frames are received from the various access points, the connection history of the various access points may be searched. As a result, if the connection history on the access point (the first access point) that has transmitted the beacon frame exists, its connection history is compared with the connection history of the other access points in operation S312. Comparing the connection history of the other access points is a process that includes selecting and determining the access point to which a connection can be preferentially be made based on previous connection history of the first connectable access point and the other access points. The access point is selected through the selection process in operation S320. The selection is made to automatically associate with the selected access point to serve as a guide, and the user may select the access point based on the guided result. The selection may be performed through a Graphic User Interface (GUI) displayed on the screen 301 as shown in FIG. 2. Information on the number of connection, connection termination, disassociation or the like, each of which is generated during a process to connect through the selected access point or to the selected access point, is stored in operation S330. Afterwards, guide information for judging whether to connect with the access point is provided.

Meanwhile, the connection history of the corresponding access point may not be available. For example, is the connection history may not be available when connection to a new access point is attempted or when the connection history of the access point is deleted after a predetermined time. If the connection history does not exist or is otherwise unavailable, information which may be obtained at the present. That is, the information, while connected or while attempting to connect to the access point, is used as a basis to guide the selecting and the storing of the communication quality in operation S316. Also, if the current connection history of an access point is stored, and it is an access point which does not satisfy a predetermined standard for connectable access points, then a connection may be made through an access point without the connection history. Accordingly, in determining an access point to recommend, information, metrics, and/or factors may be used to either include or exclude an access point in the recommendation or guidance.

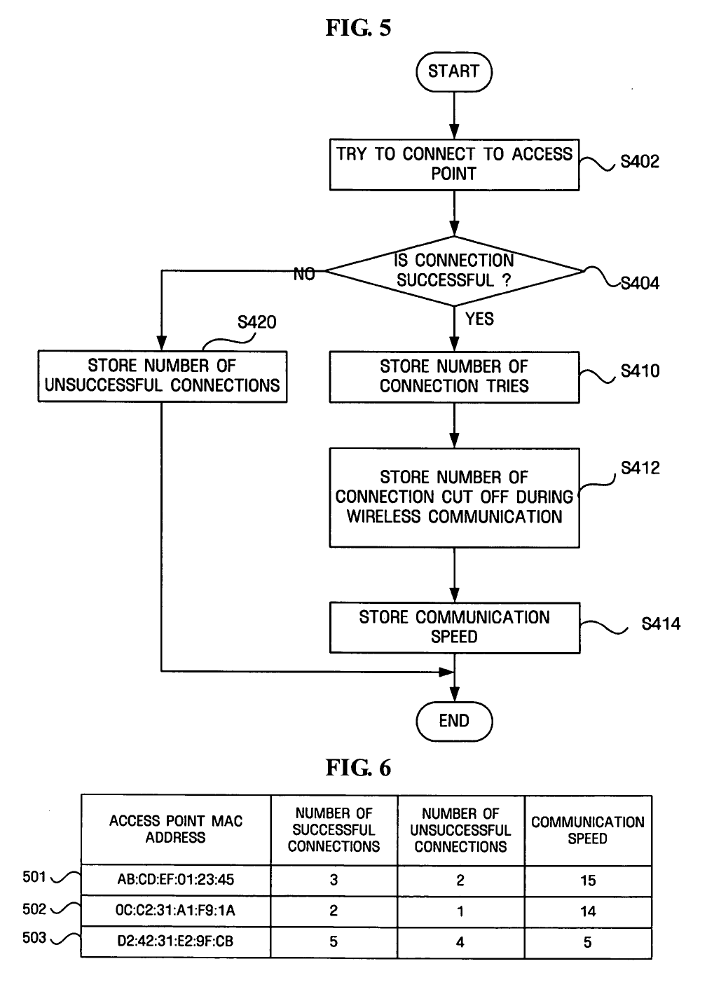

FIG. 5 is a flow chart illustrating a process for updating data by the information updating unit 254 when connected to an access point according to an aspect of the present invention. The information updating unit 254 may store a connection history of a currently connected access point or update previously stored data, and provide a recommendation or guidance, when a system is subsequently connected to the access point. Accordingly, the connection history may be the number of attempts to be associated to the access point, the number of connection cut off occurring during the connection, or the like. Further, unsuccessful attempts to associate or to connect to the access point may be stored in the connection history.

The association or connection to the access point is tried in operation S402. Such attempt may be performed through the wireless transmitting/receiving unit 210. If the association is successful in operation S404, the number of attempts at association is stored in operation S410. Further, the number of the connection cuts off occurring during wireless communication is stored in operation S412. Subsequently, if a reconnection is performed, the number of or attempts at reconnection may also be stored. A communication speed or connection speed occurring or achieved during data transfer is stored in operation S414. Some or all of the information may be used to provide a guide, guidance, or a recommendation to select an access point. Such access points may be access points having various qualities such as high speed connections and the like. For items referred above, information necessary for selecting the access point may be updated and stored by the information updating unit 254. Meanwhile, if the connection fails, the number of such failure is stored in the storage unit 256 in operation S420. In various aspects of the present invention, some of the operations need not be done sequentially but may be done simultaneously. Additionally, the order of the operations may be changed and the operations may be duplicated or performed repeatedly.

The stored connection history allows according a priority based on a predetermined standard and provides guidance so as to allow selection of an access point having a higher quality connection.

As illustrated in FIG. 5, if the connection history of the access point is continuously stored and updated, information as to the connection of the access point is accumulated, and as a result, recommendation or guidance may be provided based on the latest updated information. Accordingly, data having high reliability may be provided to the user.

FIG. 6 is a database (DB) configuration diagram illustrating a format for use with a connection history of an access point which is stored in the storage unit 256 according to an aspect of the present invention. As shown, MAC addresses are stored as an example identifier for distinguishing the various access points. Information on the number of successful connections, the number of connection termination, and communication speed are stored according to a corresponding MAC address. The information updating unit 254 stores information relative to a new MAC address of an access point and/or updates new information relative to the previously stored MAC address of the access point.

The comparison selecting unit 252 judges or determines which access point should be selected using information of the database. For example, in FIG. 6, a reference numeral 501 is a listing for an access point having a MAC address of M:DC:EF:01:23:45. As shown, the access point's number of connection success is 3, and the number of connection termination is 2. Further, a reference numeral 503 is a listing for an access point having a MAC address of D2:42:31:E2:9F:CB. As shown, the access point's number of connection success is 5 and the number of connection termination is 4. The number of connection success of the access point 503 is higher than that of the access point 501. However, access point 501 has a higher rate of a successful connection than that of the access point 503 (i.e., 60.0% vs. 55.6%). The comparison selecting unit 252 determines the standard for which to base the selection of an access point to guide or recommend a connection to the access point better meeting the standard. In various aspects of the present invention, the standard may also be various performance ratios such as a higher success rate, a lower failure rate, or the like. In other aspects, the standard may be absolute values such as the number of connections, failures, communication speed, or the like. In other aspects, the standard may be a combination or based on a function that takes account of the various data, and be determined by a user according to need (e.g., need for speed is greater than reliability).

As described above, the process of guiding the access point having a high connection rate is mainly explained. Additionally, it is possible to perform a process of selecting and displaying the access point having a low connection rate, so that the user does not select the corresponding access point.

Aspects of the present invention can increase the quality of the wireless network communication link by providing recommendation or guidance for a stable access point among a plurality of searched access points to the user of the wireless network. Aspects of the present invention are applicable to wired networks as well.

Aspects of the present invention can update connection information on access points continuously, thereby being capable of being connected to the stable access point.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. A method for providing guidance to be associated with a stable access point using a previous connection history, the method comprising:
receiving data from a plurality of access points which are available in a wireless network, and respectively searching connection information related to a connection history on the access points using an identifier of the respective access points which are included in the received data;
selecting a first access point which can be used to preferentially connect to the wireless network among the plurality of access points according to a predetermined standard in response to the searched connection information, and outputting a guidance information of the first access point;
connecting to the wireless network through the first access point; and
transmitting and/or receiving data to and/or from the wireless network through the first access point, and storing connection information including results of the transmission and/or the reception of the data.

2. The method of claim 1, wherein the predetermined standard is a standard obtained by arraying a ratio of successful connections to unsuccessful connections, a data transmission rate, a ratio rejected connections to accepted connections, and/or a ratio of failed connections to successful connections, each of which is calculated on the basis of a result of the previous connection of the access point.

3. The method of claim 1, wherein the received data is beacon data transmitted from the access points.

4. The method of claim 1, wherein the connection information includes at least one of a number of successful connections, a number of failed connections, and a number of cut off connections, each of which is calculated by attempts at a connection with the plurality of access point.

5. The method of claim 1, wherein the connection information includes at least one of a service set identifier (SSID) of an access point, a media access control (MAC) address, a number of successful connections, a number of disassociations, a number of de-authentications, and a strength of an average signal, in order to establish the connection of the wireless network.

6. The method of claim 1, wherein a number of successful connections are calculated by counting a status code of an authentication response frame, which records a “0when the connections are successful.

7. The method of claim 1, wherein the connection information uses information of a status code or a reason code to store the connection information, when the wireless network complies with the IEEE 802.11 protocol.

8. The method of claim 1, further comprising receiving an input of the first access point after outputting the guide information.

9. A wireless communication system comprising:
a wireless transmitting/receiving unit connected to a wireless network through an access point to transmit and to receive data and/or from the access point;
a storage unit to store connection information on the access point;
an information updating unit to store the connection information on the access point in the storage unit or to change the connection information stored in the storage unit; and
a comparison selecting unit to search the connection information related to a connection history for the respective access point using an identifier of the access point included in a control data to compare connection information between the access point and the other access point to which the system is connectable, and to be preferentially connected to the first access point selected according to a predetermined standard over the another when two or more access points transmit and/or receive the control data.

10. The system of claim 9, wherein the predetermined standard is obtained by arraying a ratio of successful connections to unsuccessful connections, a data transmission rate, a ratio of rejected connections to accepted connections, and/or a ratio of failed connections to successful connections, each of which is calculated based on a previously connected result for the access point which transmits the control data.

11. The system of claim 9, wherein the connection information includes at least one of a number of successful connections, a number of failed connections, and a number of cut off connections, each of which is calculated by attempts at connection to the access point.

12. The system of claim 9, wherein the connection information includes at least one of a service set identifier (SSID) of an access point, a media access control (MAC) address, a number of successful connections, a number disassociations, a number of de-authentications, and a strength of an average signal.

13. The system of claim 12, wherein the number of the successful connections is calculated by counting a status code of an authentication response frame, which records a “0” when the connection is successful.

14. The system of claim 9, wherein the connection information uses information of a status code or a reason code to store the connection information when the wireless network complies with the IEEE 802.11 protocol.

15. The system of claim 9, wherein the information updating unit stores generated information at least one of when the system is connected to the access point, fails to establish the connection, and while data is transmitted and received after the connection is established.

16. A network system comprising:
access points to connect to a wireless network; and
a system associated with the wireless network through one of the access points;
wherein, prior to selecting one of the access points, the system searches connection information related to a previous connection history of the plurality of access points, outputs guide information to preferentially connect to a first access point selected according to a predetermined standard among the plurality of access points, and connects to the first access point.

17. The system of claim 16, wherein the predetermined standard is obtained by arraying a ratio of successful connections to unsuccessful connections, a data transmission rate, a ratio of rejected connections to accepted connections, and/or a ratio of failed connections to successful connections, each of which is calculated based on a previously connected result for the access point which transmits the control data.

18. The system of claim 16, wherein the connection information includes at least one of a number of successful connections, a number of failed connections, and a number of cut off connections, each of which is calculated by attempts at connection to the access point.

19. The system of claim 16, wherein the connection information includes at least one of a service set identifier (SSID) of an access point, a media access control (MAC) address, a number of successful connections, a number of disassociations, a number of de-authentications, and a strength of an average signal, in order to establish the connection of the wireless network.

20. A method of providing guidance for access points of a network, comprising:
comparing stored metrics for a plurality of access points connectable to a wireless device;
determining at least one of the plurality of access points to recommend to connect to the network based on the stored metrics; and
outputting the recommendation.

21. The method of claim 20, wherein the metrics include at least one of a number of successful connections, a number of failed connections, a number of cut off connections, a data transmission rate, a number of disassociations, a number of de-authentications, and a strength of an average signal, or combinations thereof.

22. The method of claim 20, wherein the access points are identified using one or both of a service set identifier (SSID) of an access point and a media access control (MAC) address.

23. The method of claim 20, wherein the output of the recommendation is highlighting the one access point.

24. The method of claim 20, wherein the network is one or both of a wireless network and a wired network.

25. A network communication system to provide guidance for access points of a network, comprising a recommending unit to retrieve and compare stored metrics for a plurality of access points, determine at least one of the plurality of access points to recommend to connect to the network based on the compared metrics, and output the recommendation.

26. The system of claim 25, wherein the metrics include a number of successful connections, a number of failed connections, a number of cut off connections, a data transmission rate, a number of disassociations, a number of de-authentications, and a strength of an average signal, or combinations thereof.

27. The system of claim 25, wherein the access points are identified using one or both of a service set identifier (SSID) of an access point and a media access control (MAC) address.

28. The system of claim 25, wherein the output of the recommendation is to highlight the one access point.

29. The system of claim 25, wherein the network is one or both of a wireless network and a wired network.
